(19) United States
(12) Patent Application Publication
(10) Pub. No.: US 2018/0260571 A1
(43) Pub. Date: Sep. 13, 2018

(54) Automatically Reducing An Attack Surface of an Application Program on a Computing Device

(71) Applicant: Adobe Systems Incorporated, San Jose, CA (US)

(72) Inventors: ANTONIO SANSO, Paderborn (CH); CARSTEN ZIEGELER, Paderborn (DE)

(21) Appl. No.: 15/452,397

(22) Filed: Mar. 7, 2017

(51) Int. Cl. G06F 21/57; G06F 21/31; G06F 9/445

(52) U.S. Cl. CPC G06F 21/577; G06F 2221/033; G06F 8/61; G06F 21/31

(57) ABSTRACT

Certain embodiments involve automatically reducing an attack surface of an application program on a computing device. For example, a processor installs an application program on a computing device by copying application program data associated with the application program on a memory of the computing device. The application program data includes installation data for installing the application program on the computing device and execution data for executing a function of the application program on the computing device. The processor accesses the application program data on the memory and identifies, based on an analysis of the application program data, the installation data and the execution data. The processor reduces an attack surface of the application program by automatically removing the identified installation data from the memory of the computing device. The attack surface corresponding to a vulnerability of the application program or the computing device to access by an unauthorized user.

### TECHNICAL FIELD

This disclosure generally relates to attack surfaces of application programs, and more specifically relates to automatically reducing an attack surface of an application program following installation on a computing device to improve the security of the application program.

### BACKGROUND

An application program is a computer program configured to perform one or more functions, tasks, etc., via a computing device. The application program includes software such as, for example, various program files, instructions, or program code, that can be executed by a processor of the computing device to install the application program on the computing device and to perform the one or more functions of the application program. For example, the processor can copy or transfer the program code or one or more program files of the application program to a memory of the computing device to install the application program. The processor can then execute the copied program code or program files such that the application program can be used to perform one or more functions or tasks.

Once installed on a computing device, some application programs may be susceptible to attack. For example, an unauthorized user (e.g., a hacker) may use code from an application program to obtain unauthorized access to the software of the application program installed on the computing device or data on the computing device. In some instances, the unauthorized user attempts to access or extract data from the application program or computing device via an attack surface of the application program. The attack surface includes one or more entry points in the code of the application program through which the unauthorized user can access or extract data from the application program or the computing device. Examples of such entry points include program files, instructions, bundles, layers, etc. of the application program that can be leveraged by an unauthorized user to gain access to the application program or computing device. Thus, for instance, application programs that include various layers or bundles (e.g., groups) of program files, instructions, or program code may have a large attack surface and may be susceptible to such attacks.

### SUMMARY

Various embodiments of the present disclosure provide systems and methods for automatically (e.g., without user input or user involvement) reducing an attack surface of an application program on a computing device.

In one example, a method for automatically reducing an attack surface of an application program on a computing device includes installing, by a processor, an application program on a computing device. Installing the application program on the computing device comprises copying application program data associated with the application program on a memory of the computing device. The application program data comprises installation data for installing the application program on the computing device and execution data for executing a function of the application program on the computing device. The method further includes accessing, by the processor, the application program data on the memory. The method further includes identifying, by the processor and based on an analysis of the application program data on the computing device, the installation data and the execution data. The method further includes reducing, by the processor, an attack surface of the application program by automatically removing the identified installation data from the memory of the computing device. The attack surface corresponds to a vulnerability of the application program or the computing device to access by an unauthorized user.

Additional features and advantages of exemplary embodiments of the present disclosure will be set forth in the description which follows, and in part will be obvious from the description, or will be learned by the practice of such exemplary embodiments. The foregoing summary is not an extensive overview, and it is not intended to identify key elements or indicate a scope. Rather the foregoing summary identifies aspects of embodiments as a prelude to the detailed description presented below.

### BRIEF DESCRIPTION OF THE DRAWINGS

Features, embodiments, and advantages of the present disclosure are better understood when the following Detailed Description is read with reference to the accompanying drawings.

FIG. 1 is an example of an attack surface reduction system that automatically reduces an attack surface of an application program on a computing device, according to certain embodiments.

FIG. 2 is a flow chart depicting an example of a process for automatically reducing an attack surface of an application program on a computing device, according to certain embodiments.

FIG. 3 is an example of a block diagram of a computing device that executes an attack surface reduction system to automatically reduce an attack surface of an application program on the computing device, according to certain embodiments.

### DETAILED DESCRIPTION

Various embodiments of the present disclosure involve automatically (e.g., without user input or user involvement) reducing an attack surface of an application program by automatically uninstalling a portion of the software or data of the application program after installing the application program on a computing device. Certain embodiments avoid limitations of existing solutions for reducing an attack surface, which may involve manually removing or uninstalling one or more program files, program code, or instructions of the application program, which requires human involvement or intervention and may cause errors in the application program. These embodiments involve automatically reducing an attack surface of an application program on a computing device by automatically identifying one or more program files, program code, or instructions of the application program that introduce vulnerability to the application program or computing device once installed and uninstalling, deleting, or otherwise removing the program files, program code, or instructions. Reducing the attack surface of an application program following installation of the application program on a computing device improves the security of the application program by eliminating entry points through which an unauthorized user can access the computing device on which the application program is installed.

In one example, software of an application program includes various program files, program code, or instructions executable by a processor of a computing device that cause the processor to install the application program on the computing device by copying or transferring program code or one or more program files to a memory device of the computing device. In some examples, one or more of the program files or portions of the program code copied to the memory device are executed to install the application program on the computing device. Other portions of the program code or other program files copied to the memory device can be executed to use the application program to perform one or more functions or tasks on the computing device. Following installation, the one or more of the program files or portions of the program code executed to install the application program are not needed to use the application program to perform the functions of the application program, but may still be stored in the memory device of the computing device. Storing such program files or program code on the computing device following installation may introduce vulnerability to the application program or the computing device (e.g., make the application program or computing device vulnerable to an attack from an unauthorized user). For example, storing program files or program code not needed to use the application program to perform functions on the computing device after installation provides a larger attack surface that can be leveraged by an unauthorized user to gain access to the software of the application program or data on the computing device.

In this example, an attack surface reduction system, which may be stored in the memory device of the computing device, automatically reduces the attack surface of the application program on the computing device. For example, the attack surface reduction system analyzes the program code, program files, or instructions of the application program stored in the memory device, identifies or detects a portion of the program code, program files, or instructions that introduces vulnerability to the application program software or the computing device, and removes or uninstalls the identified program code, file, or instruction. As an example, the attack surface reduction system identifies program files that are executed to install the application program, but not needed to use the application program. The attack surface reduction system automatically uninstalls or removes the identified program files from the computing device.

In some examples, a user accesses the attack surface reduction system described above via an online service. For example, the online service includes one or more computing systems configured by program code to implement the operations describe above (e.g., implement the operations performed by the attack surface reduction system) and the user accesses the online service using a client device (e.g., a mobile telephone) via a data network.

As used herein, the term “application program” or “computer program” is used to refer to any program usable on a computing device and configured to perform a function, task, activity, etc. The application program or computer program may include instructions executable by the computing device to perform the function, task, or activity.

As used herein, the term “attack surface” is used to refer to a sum of entry points through which an unauthorized user may attempt to gain access to or extract data from an application program or a computing device such as, for example, an amount of program files, instructions, program code, bundles, layers, etc. of the application program that can be leveraged by an unauthorized user to gain access to the application program or computing device.

As used herein, the term “online service” is used to refer to one or more computing resources, including computing systems that may be configured for distributed processing operations, that provide one or more applications accessible via a data network. The collection of computing resources may be represented as a single service. In some embodiments, an online service provides a digital hub for browsing, creating, sharing, and otherwise using electronic content using one or more applications provided via the online service.

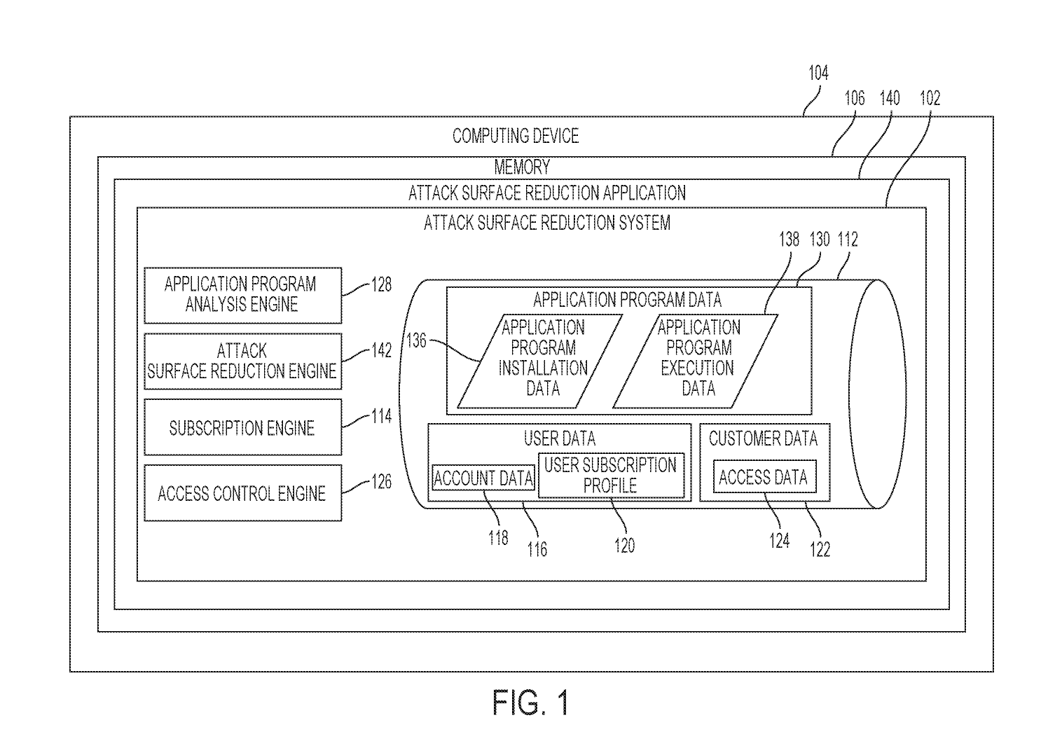

FIG. 1 is an example of an attack surface reduction system 102 that automatically reduces an attack surface of an application program on a computing device 104, according to certain embodiments. In this example, the attack surface reduction system 102 is implemented on, executed by, or stored on one or more computing devices 104. For example, the attack surface reduction system 102 is stored on a memory device 106 of the computing device 104. In some embodiments, the attack surface reduction system 102 is executed on the one or more computing devices 104 via an attack surface reduction application 140.

In some embodiments, the computing device 104 that executes the attack surface reduction system 102 also includes a data storage unit 112. In some examples, the data storage unit 112 is implemented as one or more databases or one or more data servers. The data storage unit 112 includes data that may be used by the engines of the attack surface reduction system 102.

In some embodiments, the user of the computing device 104 visits a webpage or an application store to explore applications supported by the attack surface reduction system 102. The attack surface reduction system 102 provides the applications as a software as a service (“SaaS”), or as a standalone application that may be installed on the computing device 104, or as a combination.

In some embodiments, the user creates an account with the attack surface reduction system 102 by providing user details and by creating login details. In additional or alternative embodiments, the attack surface reduction system 102 automatically creates login details for the user in response to receipt of the user details. The user may also contact the entity offering the services of the attack surface reduction system 102 and get the account created through the entity. The user details are received by a subscription engine 114 and stored as user data 116 in the data storage unit 112. In some embodiments, the user data 116 further includes account data 118, under which the user details are stored. In some embodiments, the user is also prompted to install an application manager. The application manager enables the user to manage installation of various applications supported by the attack surface reduction system 102.

In some embodiments, a user opts for a trial or a subscription to one or more engines of the attack surface reduction system 102. Based on the trial account or the subscription details of the user, a user subscription profile 120 is generated by the subscription engine 114 and stored. The user subscription profile 120 is stored in the data storage unit 112 and indicates entitlement of the user to various products or services. The user subscription profile 120 also indicates a type of subscription, e.g., a free trial, a premium subscription, or a regular subscription.

In some embodiment, the attack surface reduction system 102 is stored on the computing device 104 and the computing device 104 executes each engine of the attack surface reduction system 102 to store customer data 122 for the user in the data storage unit 112. In some examples, the user or the entity of the user has one or more customers, including potential customers, and hence, the one or more engines of the attack surface reduction system 102 store the customer data 122. In some examples, the customer data 122 is shared across these engines or is specific to each engine. In some embodiments, access data 124 is a part of the customer data 122. Access to the customer data 122 is controlled by an access control engine 126 executed on the computing device 104. The access control engine 126 determines if the user has access to a particular customer data 122 based on the subscription of the user and access rights of the user.

In some embodiments, the computing device 104 executes the attack surface reduction system 102. The attack surface reduction system 102 includes the application program analysis engine 128 and an attack surface reduction engine 142, which can each be executed on the computing device 104. For example, the engines 128, 142 each include one or more instructions stored on a computer-readable storage medium and executable by processors of the computing device 104. When executed by the one or more processors, the computer-executable instructions of the attack surface reduction system 102 cause the attack surface reduction system 102 to automatically reduce an attack surface of an application program installed on the computing device 104.

In the example depicted in FIG. 1, one or more engines 114, 126, 128, 142 of the attack surface reduction system 102 and the data storage unit 112 communicate data. For example, the data storage unit 112 transmits application program data 130 to the application program analysis engine 128. Application program data 130 includes, but is not limited to, data indicating program code, program files, or instructions of an application program that has been installed on the computing device 104. In additional or alternative embodiments, the application program analysis engine 128 obtains application program data 130 from the memory device 106, the data storage unit 112, or any other source.

In some embodiments, the attack surface reduction system 102 automatically reduces the attack surface of an application program on the computing device 104.

For example, an application program includes software such as, for example, program files, instructions, or program code. The software can be executed by one or more processing devices of the computing device 104 to install the application program on the computing device 104 or to perform a function of the application program. For example, the software of the application program includes installation software such as, for example, installation program code, files, or instructions. The installation software is executed by the one or more processing devices and causes the processing device to install the application program on the computing device 104. In some embodiments, the installation software includes program codes, files, or instructions executed to install the application program on the computing device 104, but not needed to use the application program on the computing device 104. For example, the installation software includes program code not needed to use the application program to perform a function of the application program. In this example, the software of the application program also includes execution software such as, for example, execution program code, files, or instructions. The execution software is executed by the one or more processing devices to perform a function of the application program on the computing device 104. In some embodiments, the one or more processing devices copy or transfer the various program files, instructions, or program code of the application program to a memory or database of the computing device 104 when installing the application program on the computing device 104. For example, the one or more processing devices copy the installation software and the execution software to the data storage unit 112 of the attack surface reduction system 102 that is stored on the computing device 104 during installation.

In some embodiments, the data storage unit 112 stores data indicating the copied program code, program files, or instructions. The data storage unit 112 stores the data as application program data 130. As an example, the application program data 130 includes installation software, which is stored as application program installation data 136 and the execution software, which is stored as application program execution data 138. The data storage unit 112 then transmits the application program data 130 to the application program analysis engine 128.

In some embodiments, the application program analysis engine 128 analyzes the application program data 130 and identifies or detects a portion of the copied program code, program files, or instructions. For example, the application program analysis engine 128 analyzes the application program data 130. The application program analysis engine 128 detects or determines program files used to install the application program on the computing device 104. The application program analysis engine 128 determines that these program files are not needed to use the application program on the computing device 104 (e.g., program files not needed to perform a function of the application program). In this example, the application program analysis engine 128 identifies the detected program files as application program installation data 136. As an illustrative example, the application program analysis engine 128 analyzes application program data 130. The application program analysis engine 128 identifies a portion of the application program installation data 136 that causes the computing device 104 to output a request for user input from a user of the computing device 104 during installation of the application program. For example, the application program analysis engine identifies the portion of the application program installation data 136 that causes the computing device 104 to output a request to the user to provide or set an administrator password, a request to the user to provide user input confirming installation of the application program, or a request for any other user input prior to completing installation. In this example, the identified portion of the application program installation data 136 is executed during installation of the application program, but is not needed to use the application program to perform a function of the application program on the computing device 104 once the application program is installed.

In some embodiments, the application program analysis engine 128 is electrically or communicatively coupled to the attack surface reduction engine 142. The attack surface reduction engine 142 accesses data on the application program analysis engine 128. In another example, the attack surface reduction engine 142 receives or obtains data from the application program analysis engine 128. In some embodiments, the attack surface reduction engine 142 automatically reduces an attack surface of an installed application program based on the data accessed, obtained, or received from the application program analysis engine 128.

For example, the attack surface reduction engine 142 receives data indicating a portion of the application program installation data 136 identified by the application program analysis engine 128. The attack surface reduction engine 142 then automatically removes or uninstalls the identified portion of the application program installation data 136 from the memory of the computing device 104 or from the data storage unit 112. Automatically removing or uninstalling the identified portion of the application program installation data 136 automatically reduces the attack surface of the application program and improves the security of the application program. For example, storing the identified portion of the application program installation data 136 in the memory of the computing device 104 or in the data storage unit 112 after the application program is installed introduces vulnerability to the application program or computing device 104. As an example, an unauthorized user may leverage the identified portion of the application program installation data 136 to gain access to, or obtain data from, the computing device 104 or the application program. Automatically removing or uninstalling the identified program code, files, or instructions of the application program installation data 136 eliminates entry points through which the unauthorized user can access the computing device 104, which reduces the attack surface of the application program and improves the security of the application program.

In this manner, the attack surface reduction system 102 identifies or detects a portion of the software of an installed application program that introduces vulnerability to the application program or the computing device 104 and automatically uninstalls or removes the identified portion of the software.

In the example depicted in FIG. 1, a user interfaces with the one or more computing devices 104 to access the attack surface reduction system 102. In some embodiments, the computing device 104 represents various types of client devices. For example, the computing device 104 is a mobile device (e.g., a mobile telephone, a smartphone, a PDA, a tablet, a laptop, a camera, a watch, a wearable device, etc.). The computing device 104, however, in some embodiments, is a non-mobile device (e.g., a desktop computer or another type of client device). In some examples, the computing device 104 include one or more of the components of the attack surface reduction system 102.

Although FIG. 1 illustrates a particular arrangement of the attack surface reduction system 102, computing device 104, and the data storage unit 112, various additional arrangements are possible. As an example, while FIG. 1 illustrates the application program analysis engine 128, the attack surface reduction engine 142, the data storage unit 112, and the attack surface reduction system 102 as part of a single system, in some embodiments, the application program analysis engine 128, the data storage unit 112, and the attack surface reduction system 102 are separate components that may be implemented using different servers.

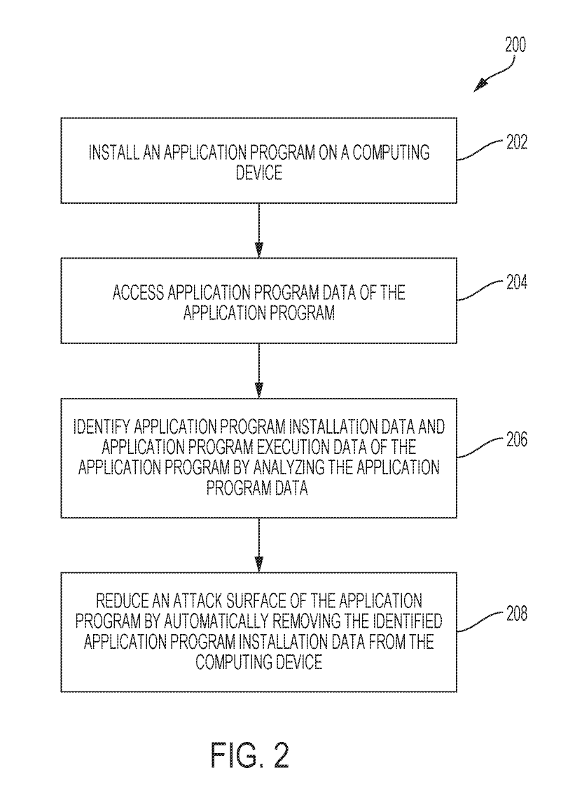

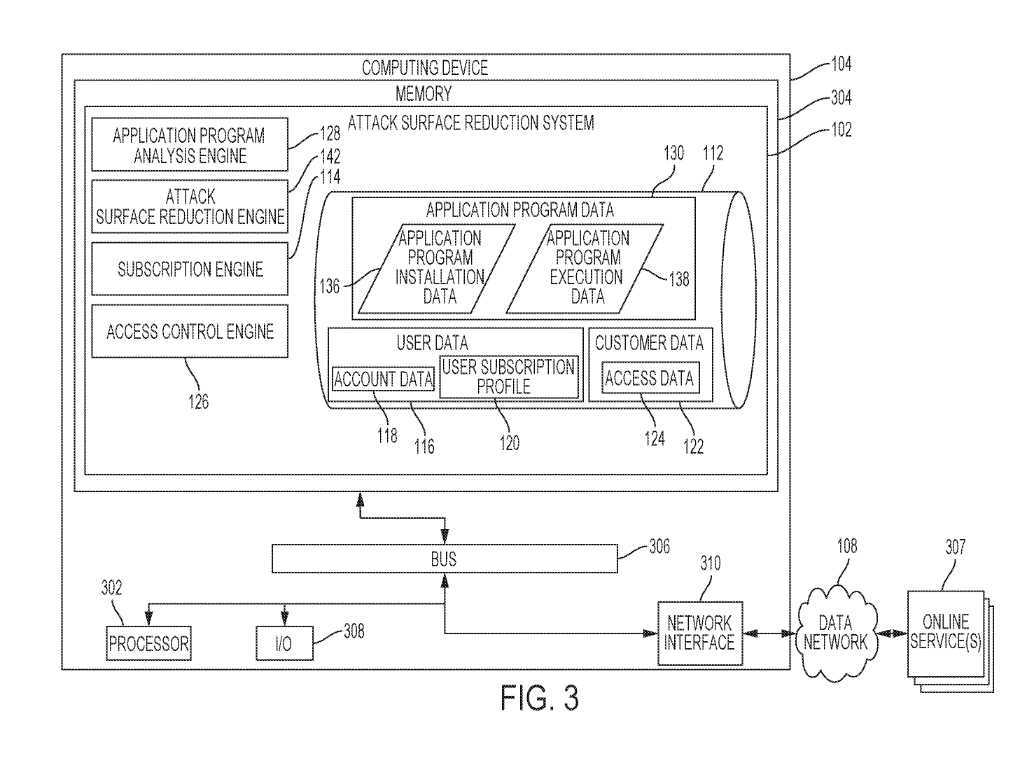

FIG. 2 is a flow chart depicting an example of a process 200 for automatically reducing an attack surface of an application program on a computing device, according to certain embodiments. In some embodiments, one or more processing devices such as, for example, the computing system described herein with respect to FIG. 3, implement operations depicted in FIG. 2 by executing suitable program code (e.g., the attack surface reduction system 102 of FIG. 1) that implements one or more algorithms encompassed by the process 200. For illustrative purposes, the process 200 is described with reference to the examples depicted in FIG. 1, but other implementations are possible.

In block 202, an application program is installed on a computing device 104. In some embodiments, the application program includes software such as, for example, program files, instructions, or program code that can be executed by one or more processing devices of the computing device 104. For example, the software includes installation software that includes program code, files, or instructions that are executed by the one or more processing devices. The installation software, when executed, causes the processing device to install the application program on the computing device 104. In some embodiments, the installation software includes program codes, files, or instructions executed to install the application program on the computing device 104, but not needed to use the application program to perform a function of the application program. The software of the application program also includes execution software that includes program code, files, or instructions that are executed by the one or more processing devices to perform a function of the application program on the computing device 104.

In some embodiments, the one or more processing devices copy or transfer the installation software and the execution software of the application program to a memory device of the computing device 104 or the data storage unit 112 when installing the application program on the computing device 104. In some embodiments, the data storage unit 112 stores the copied software of the application program as application program data 130. In some examples, the application program data 130 includes installation software, which is stored as application program installation data 136 and the execution software, which is stored as application program execution data 138.

In block 204, application program data 130 of the application program is accessed. In some embodiments, one or more processing devices execute an application program analysis engine 128 to access the data, which includes application program data 130. For example, the application program analysis engine 128 accesses, obtains, or receives the application program data 130 from one or more computing devices 104, a data storage unit 112, or any other source.

In some embodiments, the application program analysis engine 128 accesses the data from a non-transitory computer-readable medium that is local to the computing system that executes the application program analysis engine 128. Accessing the application program data 130 involves transmitting suitable electronic signals via a data bus that communicatively couples the non-transitory computer-readable medium and a processing device. These signals cause at least some of the data from the non-transitory computer-readable medium to be stored in a random-access memory or other memory device that allows rapid retrieval of data for processing operations performed by the computing system that executes the application program analysis engine 128.

In additional or alternative embodiments, the application program analysis engine 128 accesses, via a data network 108, at least some of the application program data 130 from a non-transitory computer-readable medium that is remote from the computing system that executes the application program analysis engine 128. Accessing the application program data 130 involves transmitting suitable electronic signals via a networking interface device that communicatively couples, via the data network 108, a computing system that executes the application program analysis engine 128 with another computing system that is communicatively coupled to the non-transitory computer-readable medium via a data bus or other form of local access. These signals cause at least some of the data from the non-transitory computer-readable medium to be transmitted over the data network 108, received via the network interface device of the computing system that executes the application program analysis engine 128, and stored in a random-access memory or other memory device that allows rapid retrieval of data for processing operations performed by the computing system that executes the application program analysis engine 128.

In some embodiments, the data accessed at block 204 includes data about program files, instructions, or program code of the application program. For example, the data includes the application program installation data 136 and the application program execution data 138 copied to a memory device of the computing device 104 (e.g., in block 202).

In block 206, the application program installation data 136 and application program execution data 138 of application program is identified by analyzing the application program data 130. In some embodiments, one or more processing devices execute the application program analysis engine 128 to analyze the application program data 130 to identify or detect the application program installation data 136 and the application program execution data 138.

In some embodiments, the application program analysis engine 128 identifies or detects the application program installation data 136 and application program execution data 138 via various methods or techniques. For example, the application program analysis engine 128 analyzes the application program data 130 and detects program files executed to install the application program on the computing device 104, but not needed to use the application program to perform a function of the application program. The application program analysis engine 128 then identifies the detected program files as application program installation data 136. As still another example, the application program analysis engine 128 analyzes the application program data 130 and detects a program file that is needed to use the application program on the computing device 104 following installation and identifies the detected program file as application program execution data 138.

In some embodiments, the application program analysis engine 128 analyzes the application program data 130 and detects a portion of the instructions of the application program that causes the computing device 104 to output a request for user input from a user of the computing device 104 during installation of the application program. For example, the detected portion of the instructions can be a portion of the application program instructions that causes the computing device 104 to request a user to provide or set an administrator password, request the user to provide user input confirming installation of the application program, or request any other user input prior to completing installation. In this example, the portion of the instructions that causes the computing device 104 to output the request for user input is executed during installation of the application program, but is not needed to use the application program to perform a function of the application program once the application program is installed on the computing device 104. Thus, in some embodiments, the application program analysis engine 128 identifies the detected portion of the instructions as application program installation data 136. In another embodiment, the application program analysis engine 128 identifies the detected portion of the instructions as application program installation data 136 in response to determining that a function associated with the instructions has been performed and the function is not needed to use the application program following installation.

In block 208, an attack surface of the application program is reduced by automatically removing the identified application program installation data from the computing device 104. For example, the attack surface reduction engine 142 obtains or receives data indicating the identified application program installation data 136 or portion of the identified application program installation data 136 from the application program analysis engine 128 or any other source.

In some embodiments, the attack surface reduction engine 142 accesses or obtains the data from a non-transitory computer-readable medium that is local to the computing system that executes the attack surface reduction engine 142. Accessing or obtaining the identified application program installation data 136 or portion of the identified application program installation data 136 involves transmitting suitable electronic signals via a data bus that communicatively couples the non-transitory computer-readable medium and a processing device. These signals cause at least some of the data from the non-transitory computer-readable medium to be stored in a random-access memory or other memory device that allows rapid retrieval of data for processing operations performed by the computing system that executes the attack surface reduction engine 142.

In additional or alternative embodiments, the attack surface reduction engine 142 accesses or obtains, via a data network 108, at least some of the identified application program installation data 136 or portion of the identified application program installation data 136 from a non-transitory computer-readable medium that is remote from the computing system that executes the attack surface reduction engine 142. Accessing or obtaining the identified application program installation data 136 or portion of the identified application program installation data 136 involves transmitting suitable electronic signals via a networking interface device that communicatively couples, via the data network 108, a computing system that executes the attack surface reduction engine 142 with another computing system that is communicatively coupled to the non-transitory computer-readable medium via a data bus or other form of local access. These signals cause at least some of the data from the non-transitory computer-readable medium to be transmitted over the data network 108, received via the network interface device of the computing system that executes the attack surface reduction engine 142, and stored in a random-access memory or other memory device that allows rapid retrieval of data for processing operations performed by the computing system that executes the attack surface reduction engine 142.

In some embodiments, one or more processing devices execute the attack surface reduction engine 142 to automatically remove or uninstall the identified application program installation data 136 or a portion of the identified application program installation data 136 from the computing device 104 or from the data storage unit 112. For example, the identified application program installation data 136 or portion of the application program installation data 136 (e.g., the application program installation data 136 identified in block 206) may not be needed to use the application program following installation. Storing the identified application program installation data 136 on the computing device 104 or the data storage unit 112 following installation may introduce vulnerability to the application program or computing device 104. For example, storing the identified application program installation data 136 on the computing device 104 can make the application program or computing device 104 vulnerable to an attack from an unauthorized user. In such embodiments, the attack surface reduction engine 142 automatically removes or uninstalls the identified application program installation data 136 to reduce an amount of entry points of the application program (e.g., program files, instructions, program code, bundles, layers, etc. of the application program) through which an unauthorized user may attempt to gain access to, or extract data from, the application program or the computing device 104. Reducing the amount of entry points of the application program reduces the attack surface of the application program and improves the security of the application program.

System Implementation Example

Any suitable computing system or group of computing systems can be used for performing the operations described herein. FIG. 3 is an example of a block diagram of a computing device 104 that executes an attack surface reduction system 102 to perform the operations described herein.

The depicted example of the computing device 104 includes one or more processors communicatively coupled to one or more memory devices 304. The processor 302 executes computer-executable program code stored in the memory device 304, accesses information stored in the memory device 304, or both. Examples of the processor 302 include a microprocessor, an application-specific integrated circuit (“ASIC”), a field-programmable gate array (“FPGA”), or any other suitable processing device. The processor 302 can include any number of processing devices, including one or more processors 302 that are configured by program code to implement the operations described above, such as the operations depicted in FIG. 2 that are described with respect to processing devices.

The memory device 304 includes any suitable non-transitory computer-readable medium for storing the attack surface reduction system 102. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. One or more memory devices 304 are used to implement the operations described above, such as the operations depicted in FIG. 2 that are described with respect to one or more non-transitory computer-readable media.

The computing device 104 may also include a number of external or internal devices such as input or output devices. For example, the computing device 104 is shown with an input/output (“I/O”) interface 308 that can receive input from input devices or provide output to output devices. A bus 306 can also be included in the computing device 104. The bus 306 can communicatively couple one or more components of the computing device 104. In some embodiments, the bus 306 is used to implement the operations described above with respect to FIG. 2 that involve communicating signals via a data bus.

The computing device 104 executes program code that configures the processor 302 to perform one or more of the operations described above with respect to FIGS. 1-2. The program code includes, for example, the application program analysis engine 128, attack surface reduction engine 142, subscription engine 114, access control engine 126 or other suitable applications that perform one or more operations described herein. The program code may be resident in the memory device 304 or any suitable computer-readable medium and may be executed by the processor 302 or any other suitable processor. In some embodiments, the program code described above is stored in the memory device 304, as depicted in FIG. 3. In additional or alternative embodiments, the program code described above is stored in one or more memory devices accessible via a data network.

The computing device 104 accesses the application program data 130 in any suitable manner. In some embodiments, the application program data 130 is stored in one or more memory devices accessible via a data network 108, as in the example depicted in FIG. 3. In additional or alternative embodiments, some or all of the application program data 130 is stored in the memory device 304.

The computing device 104 depicted in FIG. 3 also includes at least one network interface 310. The network interface 310 includes any device or group of devices suitable for establishing a wired or wireless data connection to one or more data networks 108. Non-limiting examples of the network interface 310 include an Ethernet network adapter, a modem, or the like. The computing device 104 is able to communicate with one or more online services 307 using the network interface 310. In some embodiments, the network interface 310 is used to implement the operations described above with respect to FIG. 2 that involve communicating signals via a data network.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, or additions to the present subject matter as would be readily apparent to one of ordinary skill in the art.

1. A method for automatically reducing an attack surface of an application program on a computing device, the method comprising:
installing, by a processor, an application program on a computing device, wherein installing the application program on the computing device comprises copying application program data associated with the application program on a memory of the computing device, the application program data comprising installation data for installing the application program on the computing device and execution data for executing a function of the application program on the computing device;
accessing, by the processor, the application program data on the memory;
identifying, by the processor and based on an analysis of the application program data on the computing device, the installation data and the execution data; and
reducing, by the processor, an attack surface of the application program by automatically removing the identified installation data from the memory of the computing device, the attack surface corresponding to a vulnerability of the application program or the computing device to access by an unauthorized user.

2. The method of claim 1, wherein the installation data comprises program code executable by the processor to cause the processor to output a request for user input prior to completing installation of the application program on the computing device.

3. The method of claim 2, wherein the request for user input comprises a request for a password prior to completing installation of the application program on the computing device.

4. The method of claim 2, wherein the request for user input comprises a request for user input indicating confirmation to install the application program on the computing device.

5. The method of claim 1, wherein the installation data comprises program code executable by the processor to cause the processor to perform a function when installing the application program code and wherein the method further comprises removing, by the processor, the installation data after the function is performed.

6. A system comprising:
a processing device; and
a non-transitory computer-readable medium communicatively coupled to the processing device, wherein the processing device is configured to perform operations comprising:
installing an application program on a computing device, wherein installing the application program on the computing device comprises copying application program data associated with the application program on a memory of the computing device, the application program data comprising installation data for installing the application program on the computing device and execution data for executing a function of the application program on the computing device;
accessing the application program data on the memory;
identifying, based on an analysis of the application program data on the computing device, the installation data and the execution data; and
reducing, by the processor, an attack surface of the application program by automatically removing the identified installation data from the memory of the computing device, the attack surface corresponding to a vulnerability of the application program or the computing device to access by an unauthorized user.

7. The system of claim 6, wherein the installation data comprises program code executable by the processing device to cause the processing device to output a request for user input prior to completing installation of the application program on the computing device.

8. The system of claim 7, wherein the request for user input comprises a request for a password prior to completing installation of the application program on the computing device.

9. The system of claim 7, wherein the request for user input comprises a request for user input indicating confirmation to install the application program on the computing device.

10. The system of claim 6, wherein the installation data comprises program code executable by the processing device to cause the processing device to perform a function when installing the application program code and wherein the processing device is further configured to remove the installation data after the function is performed.

11. A non-transitory computer-readable medium storing program code executable by a processor for automatically reducing an attack surface of an application program on a computing device, the program code comprising:
program code for installing, by the processor, an application program on a computing device, wherein installing the application program on the computing device comprises copying application program data associated with the application program on a memory of the computing device, the application program data comprising installation data for installing the application program on the computing device and execution data for executing a function of the application program on the computing device;
program code for accessing, by the processor, the application program data on the memory;
program code for identifying, by the processor and based on an analysis of the application program data on the computing device, the installation data and the execution data; and
program code for reducing, by the processor, an attack surface of the application program by automatically removing the identified installation data from the memory of the computing device, the attack surface corresponding to a vulnerability of the application program or the computing device to access by an unauthorized user.

12. The non-transitory computer-readable medium of claim 11, wherein the installation data comprises program code executable by the processor to cause the processor to output a request for user input prior to completing installation of the application program on the computing device.

13. The non-transitory computer-readable medium of claim 12, wherein the request for user input comprises a request for a password prior to completing installation of the application program on the computing device.

14. The non-transitory computer-readable medium of claim 12, wherein the request for user input comprises a request for user input indicating confirmation to install the application program on the computing device.

15. The non-transitory computer-readable medium of claim 11, wherein the installation data comprises program code executable by the processor to cause the processor to perform a function when installing the application program code and wherein the method further comprises removing, by the processor, the installation data after the function is performed.

16. (canceled)

17. (canceled)

18. (canceled)

19. (canceled)
